(19) United States
(12) Patent Application Publication
(10) Pub. No.: US 2008/0319854 A1
(43) Pub. Date: Dec. 25, 2008

(54) REWARD SYSTEM AND METHOD FOR ONLINE CREDIT AND DEBIT CARD TRANSACTIONS

(76) Inventors: Christian Roger Duroux, Paris (FR); Alexandre Jacques Duroux, Paris (FR)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/013,743

(22) Filed: Jan. 14, 2008

Related U.S. Application Data
(63) Continuation-in-part of application No. 11/765,076, filed on Jun. 19, 2007.

(51) Int. Cl. G06Q 30/00; G06Q 40/00

(52) U.S. Cl. 705/14

(57) ABSTRACT

A reward system and method including a card issuing institution that issues debit or credit cards to cardholders. Each cardholder has a cash back account set up by the institution and a cash back program provided by said institution rewards its cardholders with a predetermined cash value dependent on the cardholder's usage of the credit or debit card used by the cardholder and depositing said cash value in the cardholder's cash back account. The institution provides the identity of at least one supplier and each cardholder has online access to said supplier so that the cardholder can purchase goods or services from the supplier upon accumulation of a predetermined amount of cash in the cardholder's cash back program. The institution provides an online clearing program for receiving sales information from the supplier when a purchase is made by a cardholder and debiting said cardholder's cash in the cash back program with the amount of the sales information. Alternatively, an internet provider may be the clearing house for the system coupled to the cardholder, the card issuing institution, and the supplier.

### CROSS-REFERENCE TO RELATED APPLICATION

This application is a continuation-in-part of application Ser. No. 11/765,076, filed Jun. 19, 2007, now pending.

### BACKGROUND

1. General Background

This disclosure relates to credit and debit card reward systems; and, more particularly, to a reward system and method for online credit and debit card transactions.

2. Related Art

Many individuals use debit and credit cards to make purchases, both in retail environments and online over the internet. Some bank and other card issuers offer a reward-based program as an incentive to the card holder for using the card. Some reward programs offer points which can be redeemed for goods or services, such as airline travel. Cardholders may shop around for the card issuer that offers the most points or other rewards.

### SUMMARY

It is an object of this disclosure to provide a reward system and method for online credit and debit card users.

It is a further object of this disclosure to provide incentive rewards to a card user that can be redeemed online at a single internet provider representing a large number of suppliers of services and/or products.

It is still another object of this disclosure to provide incentive rewards to a card user that can be redeemed online at one or more designated suppliers.

It is a further object of this disclosure to provide such a system and method that is based on specific suppliers of products and/or services.

These and other objects are preferably accomplished by providing a reward system and method including a card issuing institution that issues debit or credit cards to cardholders. Each cardholder has a cash back account set up by the institution and a cash back program provided by said institution rewards its cardholders with a predetermined cash value dependent on the cardholder's usage of the credit or debit card used by the cardholder and depositing said cash value in the cardholder's cash back account. The institution provides the identity of at least one preselected supplier, or a list of a plurality of preselected suppliers, and each cardholder has online access to each of the suppliers so that the cardholder can purchase services from the suppliers upon accumulation of a predetermined amount of cash in the cardholder's cash back program. The institution provides an online clearing program for receiving sales information from the suppliers when a purchase is made by a cardholder and debiting said cardholder's cash in the cash back program with the amount of the sales information.

Instead of the cardholders redeeming his or her incentive rewards at one or more designated suppliers, a single internet provider may be used as the redemption center representing a number of suppliers.

### DESCRIPTION OF THE DRAWING

FIG. 1 is a diagrammatic illustration of a system and method for carrying out the teachings of the disclosure; and

FIG. 2 is a diagrammatic illustration of a modification of the system and method of FIG. 1.

### DETAILED DESCRIPTION

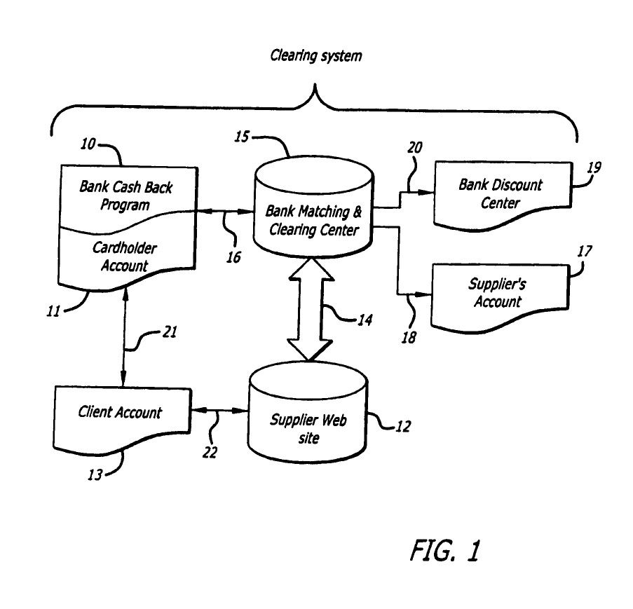

As illustrated in FIG. 1, a bank or other card issuing entity such as a travel and financial services company, an interbank credit card company, etc. sets up a cash bank program 10 at the bank or the like where the cardholder has an account 11. As the cardholder uses his card, the bank grants cash back to the cardholder based on the cardholder's card usage. The card may be a debit or credit card. The cash is accumulated by the bank and put in a cash back account, held by the bank, in the cardholder's name. The cardholder may be an individual, a small merchant, etc.

The bank maintains a list of suppliers selected by the bank, manufacturers and/or distributors, as part of the system and method of this disclosure. Alternatively, the bank may only provide the identity of a single supplier to the cardholder.

These suppliers offer a wide range of goods and services to the cardholder through its website 12. The cardholder is provided with privileged access to the website through suitable safeguards, as is well known in the art, such as a user's name, password, PIN number, etc.

Each supplier opens a client account 13 for each cardholder in the program. This account 13 is linked and matched to the cardholder's account 11 at the card issuing bank. Again, the cardholder's access to this account may be by the usual security measures or by a link to the account provided by the bank.

Optionally, as part of its program, the bank may require the suppliers to open accounts at the bank. If not, then the card issuing bank handles the transactions from bank to bank.

In operation, the cardholder checks his account, determines the amount of reward money he has in his account based on his card usage, goes to the website of a supplier offering goods or services in which he is interested and selects that item or service he wishes to purchase. The supplier then sends a request for payment, as indicated by arrow 14, to the bank maintaining account 11. As particularly contemplated in the present disclosure, if the payment request sent by the supplier to the bank, which acts as a matching and clearing center 15 for the supplier and cardholder, exceeds the amount of money in the cardholder's account 11, the cardholder has the option to charge the amount over what is in his account to his credit or debit card, or some other mean, such as an electronic pay service as PAYPAL, etc.

The bank, at its matching and clearing center 15, then debits the cardholder's account, as indicated by arrow 16, and credits the supplier's account 17 as indicated by arrow 18. The bank may, at the same time it credits the supplier's account, deduct a discount or fee for its services forwarding the same to the bank's discount center 19, as indicated by arrow 20.

Both the client account 13 and cardholder account 11 are automatically updated since, as indicated by arrow 21, both accounts are electronically matched. It should be understood, however, that a cardholder may have substantially more money in his cardholder account than credited in the client account since each supplier sets up a separate client account for each cardholder.

At this time, the supplier delivers the purchased goods, or provides the purchased services, to the cardholder in the usual form of commerce for such transactions by shipping, in store delivery, etc.

The advantages to the bank in the method and system of the disclosure are that all the transactions, between the cardholder, the bank, the various suppliers, etc. are maintained internally in the bank's system. The bank has an option to deduct a discount or percentage of each transaction thereby lessening the bank's global cash-back costs. This gives the bank the opportunity to charge more fees through both its credit/debit card program and aforementioned discounts and percentages. The going trend in the banking/cardholder industry is ecommerce. This gives the bank increased exposure and experience in this area with little if any risk. The aforementioned program is easy to implement and manage.

The advantages to the suppliers are that they have a guaranteed turnover of business due to the cardholder's cash back accounts which increases year to year. A new partnership with the bank is created.

For the cardholder, he is given access to a wide range of products and services that may not be available to the general public. In addition to the cash back from use of his credit or debit card from his bank, the supplier may credit the client's account 13, as indicated by arrow 22, with cash for future purchases. In addition, this program gives the supplier a new source of business since the supplier can issue electronic gift certificates to the cardholder, rebates offered by the manufacturer or the purchased goods, discount coupons, etc. For example, the cardholder may be given an opportunity, due to his business dealings with the supplier, to electronically purchase such items at the supplier's store or on the supplier's website, print out any discount coupons or rebates, redeem them, transfer them to another party as a gift, use them at the supplier's store or on the supplier's website or even at another supplier that may or may not have a relationship with the first supplier. In addition, the supplier could offer its own rebates or complimentary goods or services giving the cardholder a double cash back. The supplier may grant a line of credit to the cardholder that may or may not be managed by the card issuing bank.

Any suitable means of transfer of moneys may be used throughout, such as Paypal, Xoom, wire transfers, cash (e.g., Western Union), etc.

As particularly contemplated in the present disclosure, the cardholder cannot redeem the moneys in the cash back program, held by the bank, giving the cardholder a forced savings program. Once the cardholder signs up for the program, which may be offered as an incentive by the bank, he is limited in redeeming his cash back through the bank's designated suppliers.

Although the client account 13 and cardholder account 11 are shown as separate accounts in FIG. 1, they may be merged into a single account, if desired. Also, as discussed above, the card issuing institution may provide a list of suppliers to the cardholder, or only a single supplier.

It can be seen that the method and system disclosed herein affords the cardholder privileged access to a specific supplier of goods and/or services according to their needs. The plan disclosed herein integrates a real double cash back that accumulates on one single account: the e-earning account. It provides a plan that joins the cardholder's earnings to get strong leverage. The system is fully electronically managed and stimulates online purchasing. It strengthens customer loyalty, reduces costs, and increases financial flux in the form of more fees.

The advantages to the bank or other card issuing institution is that it differentiates from the latter's competitors and creates loyalty. Transactions and supplier turnover can stay internal and there is a possibility to charge more fees and grant more credits. It increases leverage on suppliers and reduces program costs. It is easy to implement and/or market and manage since it can utilize existing facilities.

For the cardholder, the latter obtains privileged access to a wide range of goods and/or services. He can choose his card according to his lifestyle and needs and benefits from a real double cash back that is easy to dispose.

As for the supplier, he gains guaranteed turnover that increases year by year and an advanced form of partnership with the bank or other credit or debit card issuers. There is a possibility to launch tailor-made offers that may include manufacturers.

It can be seen that there is disclosed a cash back reward program that provides a new avenue of commerce for a card issuing bank. It also provides a simple and easy to use online program for the cardholder, building up his credit, his ability to purchase goods and services that may be exclusive or otherwise not generally available to the public, earning cash back from his purchases, etc.

Although “cardholder” has been used throughout to generally denote an individual, obviously a small business may be a cardholder. Participation in this program may be highly desirable to a merchant that wishes to increase its Internet sales without expending resources on its own extensive marketing campaign. That is, by participation in the cash back program described herein, merchants can increase their Internet derived revenue without investing in outside marketing or advertising.

Any type of goods or services may be provided in the cash back program, such as electronic goods, other consumer goods, various types of services, lodging, retail purchases, airlines, car rentals, entertainment related activities, sporting events, sporting activities, cruises and travel packages. The documents sent to the cardholders from a merchant or the like may be personalized in various manners, such as with the user's name and a gift name.

Any suitable software or hardware may be used to carry out the teachings of the disclosure. The system and method herein can be carried out using personal computers, server computers, laptop devices, multiprocessor systems, etc. Additional examples are set-top boxes, programmable consumer electronics, handheld devices, such as phones, PDAs, etc.

The system and method may be carried out by computer programming executed by a computer. Memory storage units may be used.

A user can enter commands and information into a computer via any suitable input device, such as a keyboard, mouse, microphone, joystick, serial port, scanner, etc. Well known game units may be used that connect to the internet.

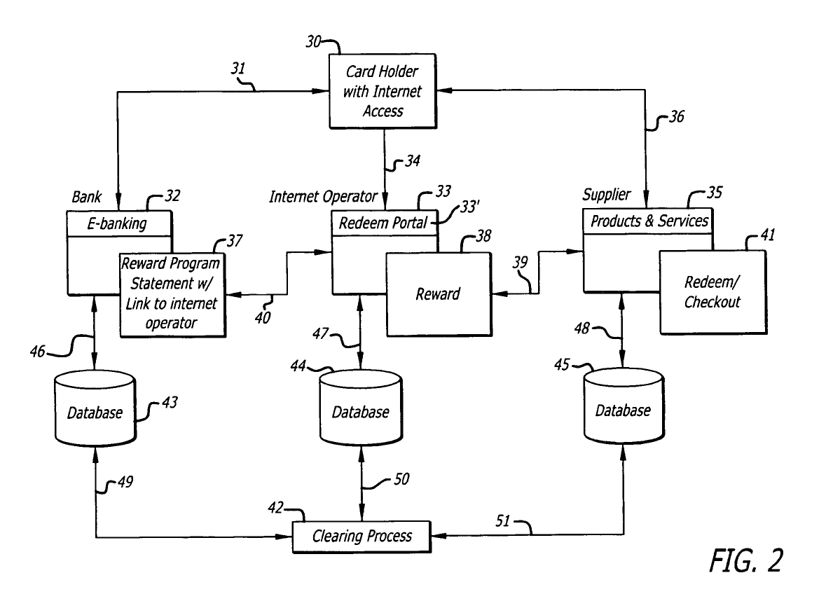

Although the reward system has been described as being associated with a bank or other card issuing entity, the latter may be part of a system utilizing an internet searching and online advertising company. Thus, as seen in FIG. 2, the cardholder 30, who has internet access through his or her home or office, or even a wireless connection, has the option, via arrow 31, to access either the bank 32, at its website, e.g., e-banking, or the website of the internet operator 33, as indicated by arrow 34. Optionally, the cardholder 30 can access the website of any supplier 35 (a single supplier 35 is shown) as indicated by arrow 36. Suitable identity controls, such as passwords, identification codes, etc. may be used at all 3 websites.

At bank 32, the cardholder 30 can access his or her account and check the cash back amount accumulated in the cardholder's reward program.

Located at the bank 32, the reward program statement 37 is linked, via arrow 40, back to the internet operator 33.

Thus, the cardholder 30 is electronically redirected to the internet operator 33 affiliated with the program in any suitable manner, e.g., html link, with or without security procedures, etc.

Internet operator 33 may be any operator on the internet. The internet operator 33 may, at its website, provide a dedicated general portal 33′, labeled “redeem portal,” for example, in FIG. 2, which portal is dedicated to the reward and redemption program. The portal 33′ may be associated with one or more banks 32, each bank having its own reward program.

The cardholder 30 can either access the bank's website 32 or the internet operator's website 33 or any supplier's website 35. In any case there can be client identification or not, secured or not, by password or not.

The client accesses the issuing bank's webpage through the e-banking or any other means. The client accesses and checks the cash back amount accumulated from his reward program.

To redeem his cash back amount the client is electronically redirected to the internet operator affiliated to the program. This link can be a mere html link, or not, including identification or not, secured or not, etc.

The internet operator can be any operator on the Internet.

The client accesses the Internet operator's webpage which organizes a general portal dedicated to reward and redeem (called redeem portal 33′ in FIG. 2). This portal can affiliate one or many banks with each their own reward program. The Internet operator 33 may organize the portal 33′ in one or many web pages, create one or many advertising spaces, with or without links to sponsors/suppliers/manufacturers/advertisers who may or may not be affiliated with the reward programs.

The internet operator 33 may create customized web pages for each bank 32, including advertising spaces. The internet operator 33 may include new technologies on all these new web pages (e.g.: to calculate advertising, etc).

The cardholder 30 may have to open an account hosted and managed by the internet operator 33. The information (e.g.: client ID, address, credit/debit card number, etc.) may be either electronically provided by the cardholder 30 or by the bank 32.

A variety of information may be provided at the internet operator's website, such as: the bank logo, its icon, the cash back amount (it may be communicated by the bank 32 by any suitable means, (e.g., a disk mirror system, may be live or not (e.g., streaming), etc. All other rewards (e.g., discounts, points, double cash back, etc.) that may be offered by the internet operator 33 or its sponsors/advertisers/suppliers/manufacturers, may be available. For example, the balance of all calculated rewards accumulated (including bank cash back amount) [a special algorithm may be developed for this purpose], the identification (name, etc.) of the cardholder 30 and any other information useful for all parties, may be provided.

This reward and redemption portal 33′ with all its web pages is linked to the general system of the internet operator 33 and is linked to the bank 32, which includes reward program 37 via arrow 40 so that the internet operator 33 may provide the frequency or origin of all the fluxes going through the portal 33′ in order to produce statistics. These statistics may be electronically (or not) communicated to the bank 32 and the suppliers 35 or any other companies concerned. Also, the portal 33′ may store and manage the redemption transactions as indicated by reward box 38.

From this portal 33′, the cardholder 30 may browse suppliers and/or products and services affiliated with the internet operator 33 and/or the bank's program. The cardholder 30 is electronically redirected to the supplier's website (a link that may include identification) as indicated by the reward box 38 linked via arrow 39 to the supplier 35.

When the cardholder 30 accesses the supplier's website from the reward portion 38 of the redeem portal 33′ (managed by the internet operator 33), the cardholder 30 may be identified (e.g.: by cookies created by the bank 32 or the internet operator 33 or the supplier 35 or all three combined) as an affiliated member of the program.

After having selected his or her products or service (e.g. by shopping at site 35) the cardholder 30 proceeds to checkout 41. At this time, information showing the reward accumulated by the cardholder 30 (on the same or on another web page) may be displayed. This display may also include the cash back that will be accumulated following the purchase, other reward/discount or advertising spaces from any sources.

The cardholder 30 then checks out and redeems his or her purchase and the following actions initiate the clearing process:

First, if the purchase amount (including any discount from the suppliers or different sponsors or all sources combined) is inferior or equal to the reward amount (cash back, double cash back, etc.), then the cardholder 30 redeems by clicking on a link (secured or not, with identification or not, etc.).

Second, if the purchase amount is superior to the reward amount, the cardholder 30 may either 1) redeem and pay the deficiency, or 2) decide not to redeem and pay the whole purchase amount.

In order to accommodate the program, the supplier 35 may need to incorporate web pages (and any other tools) into its website architecture. These new web pages and tools may be incorporated anywhere at different levels into the website architecture or more specifically into the shopping cart process and/or redeem/checkout process at the supplier 35. These web pages may be created and/or managed by the supplier 35 or by the internet operator 33 or both.

A link to the reward and redeem portal 33′ may be implemented at the supplier's website 35 as indicated by arrow 39.

The clearing process 42 may be separated from all the parties but it may be owned and/or managed by the internet operator 33 acting as a financial institution. It may also be owned and/or managed by the bank 32 affiliated to the program or any other third parties (banks, financial institutions, etc.). Another possibility is for the clearing process 42 to operate the overall transaction (including redemption) through the pre-existing clearing system of the debit or credit card used by the cardholder 30.

As seen in FIG. 2, suitable databases 43, 44 and 45 are associated, via arrows 46, 47 and 48, respectively, with bank 32, operator 33 and supplier 35, respectively. Each database may in turn be linked to clearing process 42 via arrows 49, 50 and 51, respectively.

The issuing bank 32 thus is keyed into all the financial streams so that the redemption program for each cardholder may be monitored and managed by the bank 32 so that the cardholder's cash account and/or cash back account can be debited and/or credited accordingly, with appropriate rewards, etc.

Other forms of payment may be associated with the clearing process 42. Although a single supplier 35 is illustrated in the stream shown in FIG. 2, such is for illustrative purposes only and many different suppliers may be involved.

The internet operator 33 may be any national or worldwide internet provider, e.g., a large worldwide internet searching and online advertising company.

Thus, instead of linking thousands of suppliers directly to the bank 10 in FIG. 1, a single internet provider may be interposed between the bank, the cardholder and the various suppliers.

The cash back accumulated by the cardholder will be redeemable at any of the many suppliers affiliated to the internet provider. This results in the system being easier to implement and provides many benefits to the bank. The system is thus materialized on web pages incorporated into the architecture of the provider that display the cash back accumulated by the cardholder, calculates all the cash back and discounts associated to the purchase and guides the cardholder through a privileged channel until redemption and/or checkout.

While the apparatus and method have been described in terms of what are presently considered to be the most practical and preferred embodiments, it is to be understood that the disclosure should not be limited to the disclosed embodiments. It is intended to cover various modifications and similar arrangements included within the spirit and scope of the claims, the scope of which should be accorded the broadest interpretation so as to encompass all such modifications and similar structures. The present disclose includes any and all embodiments of the following claims.

1. A reward system comprising:
a card issuing institution that issues debit or credit cards to cardholders;
a cash back account set up by said institution related to said cardholder;
cash back program means provided by said institution for rewarding its cardholders with a predetermined cash value dependent on the cardholder's usage of the credit or debit card by the cardholder and depositing said cash value in the cardholder's cash back account;
at least one supplier selected by the institution;
online supplier access means associated with said cardholder for providing online access to said supplier;
purchasing program means associated with both said cash back program and said supplier allowing purchase of goods or services from said supplier upon accumulation of a predetermined amount of cash in said cash back program; and
clearing means in said institution for receiving sales information from said supplier when a purchase is made by a cardholder and debiting said cardholder's cash in said cash back program with the amount of said sales information.

2. The system of claim 1 wherein said card issuing institution is a bank.

3. The system of claim 1 wherein said card issuing institution is a travel and financial services company.

4. The system of claim 1 wherein said card issuing institution is an interbank credit card company.

5. The system of claim 1 wherein said cardholder is an individual.

6. The system of claim 1 wherein said cardholder is a small merchant.

7. The system of claim 1 including added reward means issued by the supplier to said cardholder based on the purchases made by said cardholder from said supplier.

8. The system of claim 7 wherein said added reward means are gift certificates.

9. The system of claim 7 including indicia imprinting means associated with said gift certificates for imprinting information relating to said cardholder on said gift certificates.

10. The system of claim 7 wherein said added reward means are rebates relating to merchandise purchased by said cardholder from said supplier redeemable only by the supplier.

11. The system of claim 7 wherein said added reward means are rebates relating to merchandise purchased by the cardholder from said supplier redeemable at sources of goods or services other than said supplier.

12. The system of claim 7 wherein said added reward means are coupons issued to the cardholder for redemption on predetermined goods or services.

13. The system of claim 1 including line of credit means established by said supplier relating to the amount of business done with one or more of said cardholders.

14. The system of claim 13 wherein said line of credit means is managed by said card issuing institution.

15. The system of claim 1 including supplier bank account means relating to said selected supplier at said card issuing institution.

16. The system of claim 1 wherein said clearing means receives sales information online from said supplier.

17. The system of claim 1 including a list of a plurality of suppliers selected by the institution.

18. The system of claim 1 including a cardholder account maintained by said supplier relating to the purchases made by the cardholder from said supplier.

19. The system of claim 18 wherein said cardholder account is part of said cash back program.

20. The system of claim 1 including an internet provider electronically coupled to the cardholder, the card issuing institution, and said at least one supplier, and said clearing means.

21. The system of claim 20 wherein said internet provider is the redemption portal for said system for maintaining the reward provided to said cardholder by said cash back program means.

22. A method for carrying out online credit and debit card transactions comprising the steps of:
issuing a debit or credit card to a cardholder;
initiating a cash back account at the institution issuing said card related to said cardholder;
initiating a cash back program at said institution for rewarding its cardholders with a predetermined cash value dependent on the cardholder's usage of the credit or debit card by the cardholder;
depositing said cash value in the cardholder's cash back account;
providing the identity of a supplier selected by the institution to said cardholder;
providing online access to said cardholder for said supplier;
providing means associated with both said cash back program and said supplier for allowing purchase of goods or services from said supplier upon accumulation of a predetermined amount of cash in said cash back program; and
providing clearing means in said institution for receiving sales information from said supplier when a purchase is made by a cardholder and debiting said cardholder's cash in said cash back program with the amount of said sales information.

23. The method of claim 22 including providing added reward means issued by the supplier to said cardholders based on the purchases made by said cardholder from said supplier.

24. The method of claim 22 including the step of providing a line of credit established by one said supplier relating to the amount of business done with one or more of said cardholders.

25. The method of claim 22 including the step of electronically coupling an internet provider to the cardholder, the card issuing institution, said at least one supplier, and said clearing means.

26. The method of claim 25 wherein the step of electronically coupling said internet provider includes the step of establishing said provider as the redemption portal for said method for maintaining the reward provided to said cardholder by said cash back program.
